(19) United States
(12) Patent Application Publication
(10) Pub. No.: US 2024/0162527 A1
(43) Pub. Date: May 16, 2024

(54) APPARATUS FOR COOLING A BATTERY

(71) Applicant: Dr. Ing. h.c. F. Porsche Aktiengesellschaft, Stuttgart (DE)

(72) Inventors: Dominik Grass, Bietigheim-Bissingen (DE); Oliver Steiner, Lehrensteinsfeld (DE)

(73) Assignee: Dr. Ing. h.c. F. Porsche Aktiengesellschaft, Stuttgart (DE)

(21) Appl. No.: 18/388,909

(22) Filed: Nov. 13, 2023

(30) Foreign Application Priority Data
Nov. 14, 2022 (DE) 10 2022 130 029.3

(51) Int. Cl. H01M 10/6557; B60R 16/033; H01M 10/613; H01M 10/625; H01M 10/653; H01M 10/6555; H01M 10/658

(52) U.S. Cl. CPC H01M 10/6557; B60R 16/033; H01M 10/613; H01M 10/625; H01M 10/653; H01M 10/6555; H01M 10/658; H01M 2220/20

(57) ABSTRACT

An apparatus for cooling a battery includes a body having a surface for arranging a battery cell of the battery to be cooled. The body includes a channel for a cooling medium, wherein the channel is open at least in sections towards the surface. The body includes a material at least in the region of the channel, which material is configured so as to expand at least in sections into the channel up to the battery cell when its temperature lies above a limit value.

### CROSS-REFERENCE TO RELATED APPLICATION

This application claims priority to German Patent Application No. 10 2022 130 029.3, filed Nov. 14, 2022, the content of such application being incorporated by reference herein in its entirety.

### FIELD OF THE INVENTION

The invention relates to an apparatus for cooling a battery, a battery comprising the apparatus, and a vehicle comprising the battery.

### BACKGROUND OF THE INVENTION

EP 2065963 A2, which is incorporated by reference herein, discloses a high-voltage battery with direct cooling, in which a coolant is placed in direct contact with cells of the battery in channels provided between the cooling plates.

### SUMMARY OF THE INVENTION

The apparatus for cooling a battery provides that the apparatus comprises a body, wherein the body comprises a surface for arranging a battery cell of the battery to be cooled, wherein the body comprises a channel for a cooling medium, wherein the channel is open at least in sections towards the surface, wherein the body comprises a material at least in the region of the channel, which material is configured so as to expand at least in sections into the channel up to the battery cell when its temperature lies above a limit value. In case of an incident in which, for example, hot gases escape from the battery cell, the material swells and fills the channel up to the battery cell. This insulates the battery cell. This represents a cooling with propagation protection.

Preferably, the material is thermally insulating.

Preferably, the material is electrically insulating.

Preferably, the material is a foam.

In one embodiment, the surface comprises the material.

In one embodiment, the surface comprises a liner configured so as to separate the material from the cooling medium.

In a battery comprising the apparatus and at least one battery cell, the at least one battery cell is arranged on the surface. This battery has advantages corresponding to those of the apparatus.

A vehicle comprising the battery has advantages corresponding to those of the battery.

### BRIEF DESCRIPTION OF THE DRAWINGS

Further advantageous embodiments will emerge from the following description and the drawing. The drawing shows:

FIG. 1 depicts a schematic representation of a battery in a first state,

FIG. 2 depicts a schematic representation of the battery in a second state.

### DETAILED DESCRIPTION OF THE INVENTION

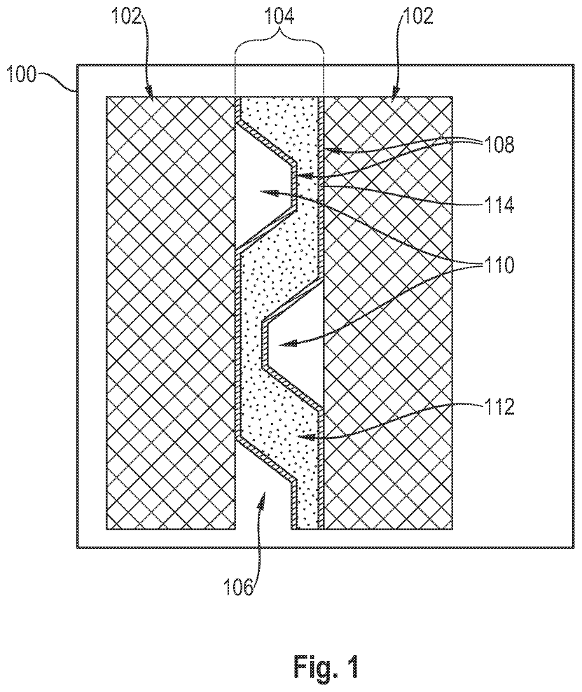

In FIG. 1, a battery 100 is schematically shown in a first state prior to an event during which hot gases leak from a battery cell 102.

In the example, the battery 100 comprises an apparatus 104 for cooling the battery 100.

The apparatus 104 comprises a body 106. The body 106 comprises a surface 108 for arranging the battery cell 102 of the battery 100 to be cooled. The body 106 comprises a channel 110 for a cooling medium.

The channel 110 is at least partially open towards the surface 108. The battery cell 102 is arranged on the surface 108. That is to say, cooling medium introduced into the channel 110 is in direct contact with the battery cell 102 when it is arranged on the surface 108.

The body 106 comprises, at least in the region of the channel 110, a material 112 configured so as to extend at least in sections into the channel 110 up to the battery cell 102, when its temperature lies above a limit value. In one embodiment, the material 112 is thermally insulating. In one embodiment, the material 112 is electrically insulating. For example, the material 112 is a foam.

In one embodiment, the surface 108 comprises the material 112. In an embodiment shown in FIG. 1, the surface 108 comprises a liner 114 configured so as to separate the material 112 from the cooling medium. The material 112 and liner 114 can be configured such that a force that is applied onto the liner 114 by expanding material is greater than a force acting against the material 112 due to the liner 114. The material 112 and liner 114 can be configured such that a force that is applied onto the liner 114 by expanding material causes a bursting of the liner 114.

In the example shown in FIG. 1, the battery 100 comprises two battery cells 102, between which the apparatus 104 for cooling the battery is arranged.

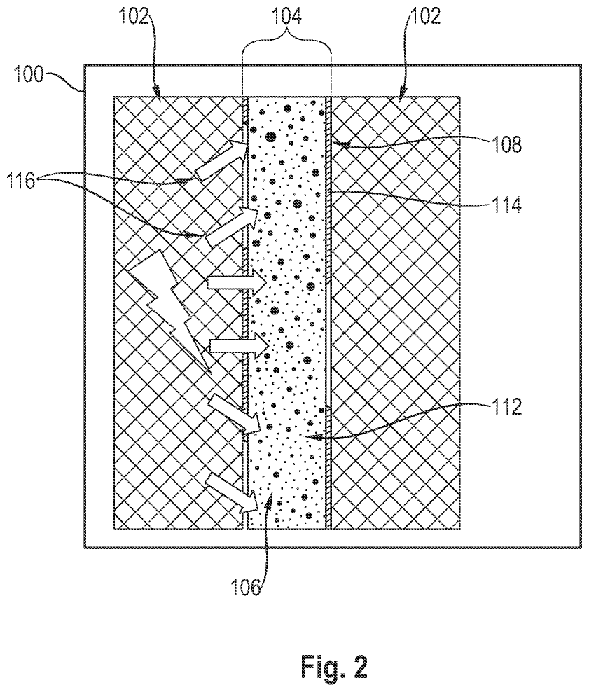

In FIG. 2, the battery 100 is schematically shown in a second state after the event during which hot gases 114 leak out of the battery cell 102. In the example, the channel 110 is completely filled. It is sufficient for the material 112 to be expanded until contact with the battery cell 102. The material 112 insulates the battery cell 102.

A vehicle can be provided, which comprises the battery 100.

For example, the limit value is a temperature at which the hot gases leak out of the battery cell 102 during the incident.

It can be contemplated that the material 112 is arranged between two surfaces of the body 106 in a full surface manner or in defined regions between the surfaces. The body is, for example, a cooling plate. In the cooling plate, e.g. between its liners, the material, in particular the foam, is e.g. installed over the full surface or in defined regions. The cooling channels or cell interstices of the battery cells 102 are thereby filled up in a thermally insulating manner. Thus, an additional thermally insulating layer is built up between the battery cells 102.

What is claimed is:

1. An apparatus for cooling a battery, wherein the apparatus comprises:
a body comprising (i) a surface upon which a battery cell of the battery can be cooled, (ii) a channel for channeling a cooling medium, wherein the channel is open at least in sections towards the surface, and (iii) a material at least in the region of the channel, which material is configured to expand at least in sections into the channel and up to the battery cell when a temperature of the material lies above a limit value.

2. The apparatus according to claim 1, wherein the material is thermally insulating.

3. The apparatus according to claim 1, wherein the material is electrically insulating.

4. The apparatus according to claim 1, wherein the material is a foam.

5. The apparatus according to claim 1, wherein the surface comprises the material.

6. The apparatus according to claim 1, wherein the surface comprises a liner configured to separate the material from the cooling medium.

7. The apparatus according to claim 1, wherein the material is arranged between two surfaces of the body in a full surface manner or in defined regions between the surfaces.

8. A battery, wherein the battery comprises the apparatus according to claim 1 and at least one battery cell, wherein the at least one battery cell is arranged on the surface.

9. A vehicle comprising the battery according to claim 8.
